(19) United States
(12) Patent Application Publication
(10) Pub. No.: US 2018/0259694 A1
(43) Pub. Date: Sep. 13, 2018

(54) OPTICAL FILTER ON A FLEXIBLE MATRIX

(71) Applicant: U.S. Army Research Laboratory ATTN: RDRL-LOC-I, Adelphi, MD (US)

(72) Inventor: Thomas C. Parker, Bel Air, MD (US)

(21) Appl. No.: 15/915,276

(22) Filed: Mar. 8, 2018

Related U.S. Application Data
(60) Provisional application No. 62/469,604, filed on Mar. 10, 2017.

(51) Int. Cl. G02B 5/28; G02B 5/20; B29D 11/00

(52) U.S. Cl. CPC G02B 5/28; G02B 5/206; B29K 2083/00; G02B 2207/107; B29D 11/00634

(57) ABSTRACT

A flexible optical filter and a method of manufacturing includes providing a porous optical filter; depositing the porous optical filter onto a substrate; coating the porous optical filter with a polymer film thereby transferring the porous optical filter to the polymer film; and removing the polymer film and attached porous optical filter from the substrate thereby creating a flexible optical filter. The porous optical filter includes nano-structures. The nano-structures include any of rods, helices, particles, and zig-zags. The removed polymer film and attached porous optical filter may be flexible. The flexible optical filter includes inorganic materials. The nano-structures may absorb an applied strain to the flexible optical filter. The nano-structures prevent the inorganic materials from being damaged upon undergoing strain. The method may further include integrating any of nano-plasmonics, electrochromic, gasochromic, thermochromic, and non-linear optic materials with the porous optical filter.

### CROSS REFERENCE TO RELATED APPLICATIONS

This application claims priority to and the benefit of U.S. Provisional Application No. 62/469,604 filed on Mar. 10, 2018 (ARL 15-39P) titled “OPTICAL FILTER ON A FLEXIBLE MATRIX” which is hereby incorporated reference herein.

### GOVERNMENT INTEREST

The embodiments herein may be manufactured, used, and/or licensed by or for the United States Government without the payment of royalties thereon.

### BACKGROUND

### Technical Field

The embodiments herein generally relate to optics, and more particularly to optical filters.

### Description of the Related Art

Optical filters are configured to selectively transmit or reject light of different wavelengths. Most optical filters are composed of glass or plastic and are colored for various applications including photography. Filters that absorb some wavelengths of light while transmitting others are called absorptive filters, which are typically made from glass and have different compounds added thereto (for example, inorganic compounds, etc.). Filters that reflect one or more spectral bands while transmitting others are called interference or dichroic filters. Typical inorganic optical filters that are composed of glass are brittle and are prone to cracking and breaking apart when under strain. Some absorptive filters are made from plastic with compounds added to create a gel filter. However, in order to protect the gel from tearing or being damaged, protective coatings are typically applied to the gel filter, which can affect the optical properties of the filter. Some optical filters are composites with glass sandwiching a gel center. However, manufacturing these filters tends to be cumbersome and prone to inconsistencies in the optical qualities.

### SUMMARY

In view of the foregoing, an embodiment herein provides a method of manufacturing comprising providing a porous optical filter; depositing the porous optical filter onto a substrate; coating the porous optical filter with a polymer film thereby transferring the porous optical filter to the polymer film; and removing the polymer film and attached porous optical filter from the substrate thereby creating a flexible optical filter. The porous optical filter may comprise nano-structures. The nano-structures may comprise any of rods, helices, particles, and zig-zags. The removed polymer film and attached porous optical filter may be flexible. The flexible optical filter may comprise inorganic materials. The nano-structures may absorb an applied strain to the flexible optical filter. The nano-structures may prevent the inorganic materials from being damaged upon undergoing strain. The method may further comprise integrating any of nano-plasmonics, electrochromic, gasochromic, thermochromic, and non-linear optic materials with the porous optical filter.

Another embodiment provides a method comprising providing a substrate; depositing a porous optical filter onto the substrate; coating the porous optical filter with a flexible film; transferring the porous optical filter to the flexible film; and removing the film and attached porous optical filter from the substrate. The porous optical filter may comprise nano-structures. The nano-structures may comprise any of rods, helices, particles, and zig-zags. The removed flexible film and attached porous optical filter may be flexible. The porous optical filter may comprise inorganic materials. The nano-structures may absorb an applied strain to the porous optical filter. The nano-structures may prevent the inorganic materials from being damaged upon undergoing strain. The method may further comprise integrating any of nano-plasmonics, electrochromic, gasochromic, thermochromic, and non-linear optic materials with the porous optical filter.

Another embodiment provides a flexible optical filter comprising a polymer film; and a porous optical filter integrated into the polymer film. The porous optical filter may comprise nano-structures. The nano-structures absorb an applied strain to the porous optical filter. The porous optical filter may comprise inorganic materials.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram of a first processing step according to an embodiment herein;

FIG. 2 is a schematic diagram of a second processing step according to an embodiment herein;

FIG. 3 is a schematic diagram of a third processing step according to an embodiment herein;

FIG. 4 is a schematic diagram of a fourth processing step according to an embodiment herein;

FIG. 5 is a schematic diagram of a fifth processing step according to an embodiment herein;

FIG. 6 is a schematic diagram of a sixth processing step according to an embodiment herein;

FIG. 7 is a scanning electron microscope (SEM) top view image of a nano-structured optical stack on a silicon wafer according to an embodiment herein; and

FIG. 8 is a flow diagram illustrating a method according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

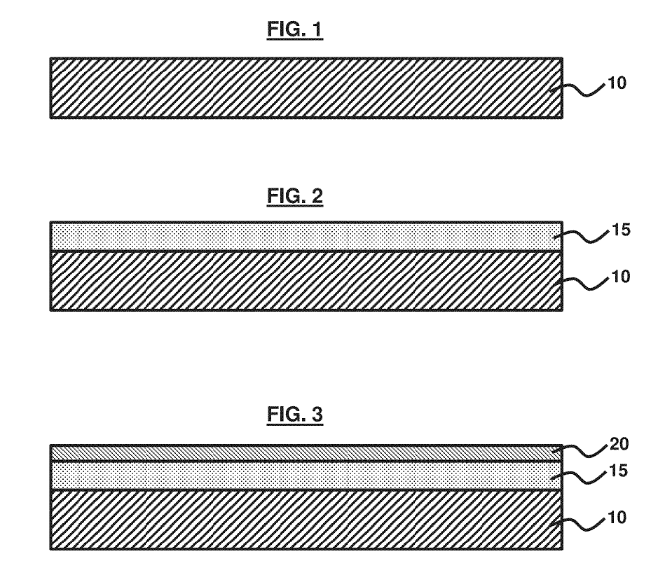

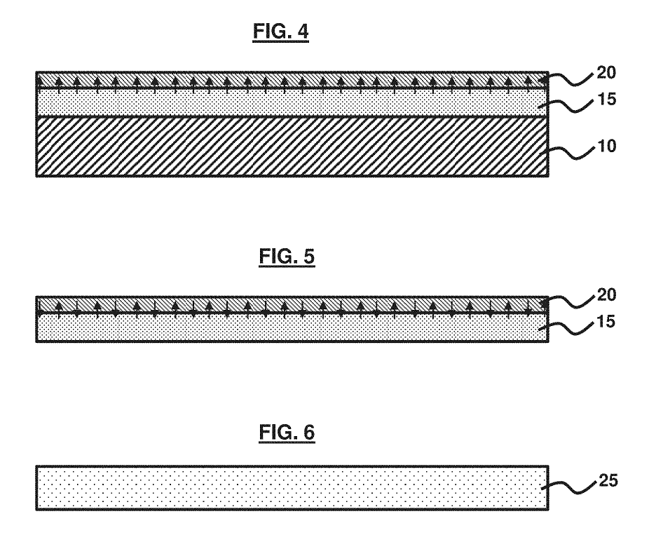

The embodiments herein provide an optical filter along with a method of manufacturing the optical filter and a transfer process to a flexible substrate. Referring now to the drawings, and more particularly to FIGS. 1 through 8, where similar reference characters denote corresponding features consistently throughout the figures, there are shown preferred embodiments.

FIGS. 1 through 6 illustrate sequential manufacturing processing steps for creating a flexible optical filter 25. The embodiments herein provide a porous optical filter 15 deposited in vacuum onto a substrate 10. The porous optical filter material can range from one nanometer to several hundred micrometers in thickness and has a columnar porous structure. Deposition times can vary from several minutes up to several days. The temperature is initially at or near room temperature; however, this may rise above room temperature (e.g., 25° C.) to 100° C. or more during the deposition process. Additionally, to control the sample crystallinity and/or porosity the sample may be heated and/or cooled. The substrate 10 is vacuum compatible and may comprise glass, ceramic, semiconductor, metal, some type of polymer, etc. The thickness of the substrate 10 is configured to provide for practical handling; i.e., if it's too thin (such as a few micrometers thick) could bend and break during handling. Accordingly, the substrate 10 has a sufficient thickness to be self-supporting, and not bend due to gravity.

The optical filter 15 is then coated with a polymer film 20, which is subsequently removed from the original substrate 10 carrying with it the optical filter 15. The polymer film 20 can be coated in the following alternative, example processes: (1) the uncured (liquid) polymer material is poured over the surface of the filter/substrate 10; placed on a hot surface or oven and cured for approximately 90 minutes at 150° C.; once cured the now solid polymer is carefully peeled off the substrate 10. (2) A vacuum polymerization process can be utilized where a vapor of a polymer monomer coats the filter/substrate 10 after sufficient coating time (sufficiently long enough to form a polymer layer that can be peeled off/handled), and the sample is removed from the polymer vacuum deposition system.

This provides an optical filter embedded in a flexible substrate (i.e., flexible optical filter 25). The flexible optical filter 25, which can have an overall thickness of approximately one nanometer to several hundred micrometers, can then be applied to any number of surfaces including glass surfaces (such as windows, electronic screens, etc.) as well as plastic surfaces, among others, thus modifying the surfaces' optical properties. X-ray photoelectron spectroscopy measurements of the surface of the polymer filter 25 can be utilized to reveal no evidence of the substrate 10 after the polymer film is removed from the substrate 10 for the case of a silicon wafer. The removal process does affect the filter properties.

The filter 25 is applied to a clean smooth surface and adheres via van der Waals force or alternatively an adhesive can be used to glue the surfaces together. The embodiments herein provide a tunable inorganic optical filter 15 that is integrated into a flexible film 20. In this regard, the structure of the optical filter 15 can be tuned to meet a specific application/spectral response. The resulting filter 25 can carry a wide array of both optical and functional properties as it can be composed on virtually any material. For example, the filter 25 can be configured as a notch filter, low pass filter, high pass filter, or other types of filters that can be formed by structural components. The porous columnar material can be formed from thermally or electrically responsive materials such as vanadium dioxide or tungsten trioxide.

The embodiments herein provide for the ability to integrate inorganic optical interference filters 15 in a polymer film matrix 20. Specialized types of absorptive filters such as nano-plasmonics could be integrated into the structure of the resulting filter 25 due to their very thin nature (e.g., 1 nm to 100 nm). The embodiments herein overcome the problems associated with conventional inorganic optical filters by utilizing an ordered, nano-structured inorganic optical filter 15 integrated into the flexible polymer matrix 20 (i.e., resulting in flexible optical filter 25). When strain is applied to the filter 25, the nano-structure enables the flexible film 20 (holding the nano-structures) to absorb the strain; thus, leaving the strain sensitive inorganic material undamaged. For example, silicon dioxide is sensitive to strain of a few percent. The strain sensitive material is what makes up the porous filter 15. The filter 15 containing this strain sensitive material is subsequently integrated into the polymer film matrix 20. Due to the porous columnar nature of the resulting optical filter 25, the strain limit is not determined by the inorganic material (generally a few percent strain before failure) but by the polymeric film/layer which can readily go to strain values of 100% or more. The nano-structure film may comprise an array of isolated columnar nanorods/pillars.

The isolated nature of the nano-structures permits the infiltration of a liquid and/or vapor between the nano-rods. Once the liquid/vapor polymerizes a solid polymer forms between the nano-rods.

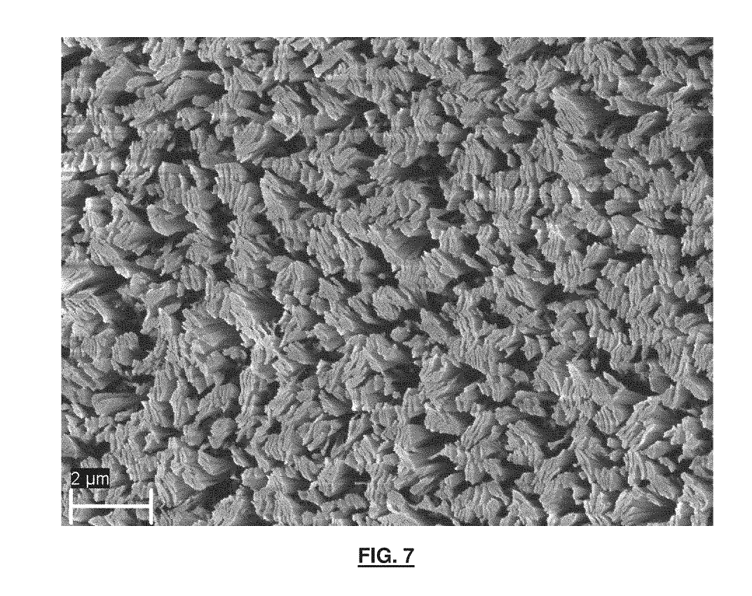

FIG. 7, with reference to FIGS. 1 through 6, is a scanning electron microscope (SEM) top view image of a nano-structured optical stack on a silicon wafer (e.g., substrate 10) according to an embodiment herein. In this regard, multiple layers may be used to form the desired filter response and this may involve multiple filters to form a net optical response. In FIG. 7 the top of the array of nano-rods and the spaces into which the polymer matrix will infiltrate are observable.

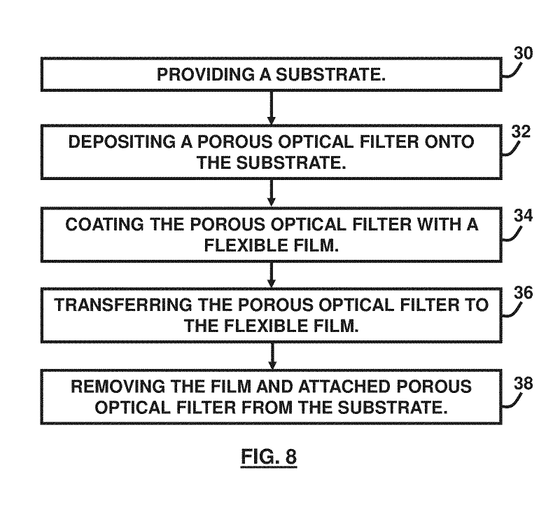

FIG. 8, with reference to FIGS. 1 through 7, is a flow diagram illustrating a method of manufacturing a flexible optical filter 25 according to an embodiment herein, wherein the method comprises providing (30) a substrate 10; depositing (32) a porous optical filter 15 onto the substrate 10; coating (34) the porous optical filter 15 with a flexible film 20;

transferring (36) the porous optical filter 15 to the flexible film 20; and removing (38) the film 20 and attached porous optical filter 15 from the substrate 10. The porous optical filter 15 may comprise nano-structures. The nano-structures may comprise any of rods, helices, particles, and zig-zags. The removed flexible film 20 and attached porous optical filter 15 are flexible. The porous optical filter 15 may comprise inorganic materials. The nano-structures absorb an applied strain to the porous optical filter 15. The nano-structures prevent the inorganic materials from being damaged upon undergoing strain. The method may further comprise integrating any of nano-plasmonics, electrochromic, gasochromic, thermochromic, and non-linear optic materials with the porous optical filter 15.

The embodiments herein may be utilized for optically encoded anti-counterfeiting applications, as well as control over transmitted/reflected/absorbed light, and enabling optical medical diagnostics, among other applications. The embodiments herein provide a technique to fabricate and integrate an optical filter 15 comprising nano-structures (e.g., rods, helices, particles, zig-zags, etc.) into a flexible polymer matrix 20. These nano-structures can be composed of virtually any material. As such filters with nano-plasmonics, electrochromic, gasochromic, thermochromic, non-linear optic materials, etc. can be integrated into the flexible optical filter 25 to add a wide range of functionality. Due to the mechanical toughness/flexibility (e.g., no degradation of the appearance of the filter 25 is observed after bending the filter 25 approximately 90 degrees) of the filter 25 (can be applied to non-planar surfaces), lightweight properties (can be down to 10′s of micrometers thick, 1 m² of filter material could be on the order of 15 grams in weight), and an array of optical properties/features that can be embedded, the embodiments herein can be applied to a wide array of systems including lightweight flying/gliding platforms, land vehicles, ships, human skin/clothing, equipment, etc.

The sample shown in top view secondary electron microscope image in FIG. 7 was fabricated using a multistep process as follows. A 2″ diameter single side polished silicon wafer was mounted to a sample stage with an adjustable tile angle. The deposition chamber was a cryo-pumped high vacuum system equipped with a multi-pocket electron beam evaporator. The sample holder was rotated to a tilt angle of 80 degrees with respect to the deposition source. Nanorod calcium fluoride film was deposited with an electron beam evaporator. The source material had a purity of 99.99% and was placed in a 7 cubic centimeter Molybdenum crucible liner which was installed in one of the 4 beam pockets. The calcium fluoride film was deposited using an electron beam acceleration voltage of 6.39 kV and a beam current of 26 mA. The beam was rastered over the calcium fluoride surface in a circular scan pattern at a rate of 1.2 Hertz. Deposition was continued until all the source material was consumed. A quartz crystal microbalance was used to monitor the deposition rate and thickness and yielded a total thickness of 355 nanometers. The expected height of the nanorods can be calculated to be Total Thickness/Cos(80) or in this deposition 355 nm/(0.1736)=2045 nanometers tall.

The crucible was rotated to the pocket containing the Au deposition source. The source Au material came in pellet form and had a purity of 99.999%. A 7 cubic centimeter graphite crucible liner was filled 75% and melted to form a hemispherical gold slug prior to the actual deposition. The sample tilt angle was rotated from the 80 degree tilt used during the calcium fluoride deposition to 45 degrees for the gold deposition. This was done to promote gold deposition on the faceted tips of the calcium fluoride nanorods. During the gold deposition the electron beam accelerating voltage was 6.39 kV without any beam sweep. A beam current of 115 mA was used and the deposition was stopped after 20 nm of gold as measured on the quartz crystal microbalance.

After permitting the ebeam source to cool down several hours the sample was removed from the vacuum chamber. The 2″ wafer with the calcium fluoride nanorod/gold film was cleaved into four pieces. One of these quarters of the sample was further processed to embed/removed the calcium fluoride nanorod/gold film in a flexible polymeric matrix. The wafer piece was placed in the center of a 3″ diameter petri dish with the nanorod film facing up. The sample was covered while the polydimethyl siloxane (PDMS) was prepared. The 250 ml of PDMS resin was mixed with 25 ml of curing agent, a 10:1 ratio per the manufacturer's guidelines. The mixture is thoroughly mixed to insure homogenous distribution of the curing agent, however this introduces many bubbles which must be removed to promote the embedding of the nanorod film in the PDMS. The PDMS is placed in a vacuum oven which reaches 25 mmHg and is kept at room temperature. The bubbles rise when under vacuum through the viscous resin then the oven is brought to atmospheric pressure with nitrogen gas removing many of the bubbles. This process is repeated until all bubbles are removed. The uncured resin is the poured over the center of the nanorod sample insuring there is no break in the pour, any breaks in the pour would introduce bubbles and interrupt the embedding of the nanorods. After all the PDMS is poured out and the sample is fully coated the petri dish is placed on a hot plate at 100 C to cure for 3 hours. After fully cured the PDMS is peeled out of the petri dish carrying the wafer embedded in it. Next the wafer is carefully removed from the PDMS leaving behind the calcium fluoride nanorod/gold film in the flexible PDMS matrix.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of manufacturing comprising:
providing a porous optical filter;
depositing said porous optical filter onto a substrate;
coating said porous optical filter with a polymer film thereby transferring said porous optical filter to said polymer film; and
removing said polymer film and attached porous optical filter from said substrate thereby creating a flexible optical filter.

2. The method of claim 1, wherein said porous optical filter comprises nano-structures.

3. The method of claim 2, wherein said nano-structures comprise any of rods, helices, particles, and zig-zags.

4. The method of claim 1, wherein the removed polymer film and attached porous optical filter are flexible.

5. The method of claim 2, wherein said flexible optical filter comprises inorganic materials.

6. The method of claim 5, wherein said nano-structures absorb an applied strain to said flexible optical filter.

7. The method of claim 6, wherein said nano-structures prevent said inorganic materials from being damaged upon undergoing strain.

8. The method of claim 1, further comprising integrating any of nano-plasmonics, electrochromic, gasochromic, thermochromic, and non-linear optic materials with said porous optical filter.

9. A method comprising:
providing a substrate;
depositing a porous optical filter onto said substrate;
coating said porous optical filter with a flexible film;
transferring said porous optical filter to said flexible film; and
removing said film and attached porous optical filter from said substrate.

10. The method of claim 9, wherein said porous optical filter comprises nano-structures.

11. The method of claim 10, wherein said nano-structures comprise any of rods, helices, particles, and zig-zags.

12. The method of claim 9, wherein the removed flexible film and attached porous optical filter are flexible.

13. The method of claim 10, wherein said porous optical filter comprises inorganic materials.

14. The method of claim 13, wherein said nano-structures absorb an applied strain to said porous optical filter.

15. The method of claim 14, wherein said nano-structures prevent said inorganic materials from being damaged upon undergoing strain.

16. The method of claim 1, further comprising integrating any of nano-plasmonics, electrochromic, gasochromic, thermochromic, and non-linear optic materials with said porous optical filter.

17. A flexible optical filter comprising:
a polymer film; and
a porous optical filter integrated into said polymer film.

18. The flexible optical filter of claim 17, wherein said porous optical filter comprises nano-structures.

19. The flexible optical filter of claim 18, wherein said nano-structures absorb an applied strain to said porous optical filter.

20. The flexible optical filter of claim 17, wherein said porous optical filter comprises inorganic materials.
